(19) United States
(12) Patent Application Publication
(10) Pub. No.: US 2016/0379304 A1
(43) Pub. Date: Dec. 29, 2016

(54) Asset Selection and Monitoring Tool

(71) Applicants: Vinesh Jha, Hong Kong (HK); Sergiusz Bleja, London (GB); Hengni Cai, New York, NY (US); William Herkelrath, Brooklyn, NY (US); Robert G. Schuessler, III, New York, NY (US)

(72) Inventors: Vinesh Jha, Hong Kong (HK); Sergiusz Bleja, London (GB); Hengni Cai, New York, NY (US); William Herkelrath, Brooklyn, NY (US); Robert G. Schuessler, III, New York, NY (US)

(73) Assignee: YouDevise Limited, trading as TIM Group, London (GB)

(21) Appl. No.: 15/000,194

(22) Filed: Jan. 19, 2016

Related U.S. Application Data
(60) Provisional application No. 62/184,649, filed on Jun. 25, 2015.

(51) Int. Cl. G06Q 40/04; G06Q 30/02

(52) U.S. Cl. CPC G06Q 40/04; G06Q 30/0202

(57) ABSTRACT

The embodiments described herein are directed to generating a predictive market indicator for an asset. In one embodiment, a computer-implemented method comprises receiving proposed trades that comprise an asset and a trade recommendation; calculating a proposed trade alpha for the proposed trades; calculating a proposed trade alpha average for the asset based on a subset of the proposed trades comprising the asset; determining an asset alpha for a plurality of assets based on the proposed trade alpha average associated with the assets; generating a ranking of the assets based on the asset alpha associated with the asset; dividing the ranking into a number of segments; determining an indicator number to assign to the assets based on a rank position associated with the assets and the number of segments associated with the ranking; and encoding for display a user interface that specifies the indicator number corresponding with the asset.

### CROSS REFERENCE TO RELATED APPLICATIONS

This application claims the benefit of, and priority to, co-pending U.S. Provisional Patent Application No. 62/184,649 entitled “TIM INDICATOR” filed on Jun. 25, 2015, which is incorporated herein by reference in its entirety.

### BACKGROUND

Oftentimes, investors receive numerous trade ideas from brokers. The brokers attempt to notify investors of favorable times to invest in particular securities. Investors use research tools to analyze the trade ideas, securities, and monitor financial market activities. From this research, investors determine whether to invest according to the trade idea.

### SUMMARY

Embodiments of the present disclosure are related to generating a market signal, or an alert, concerning an individual asset that is indicative of an activity that is unexplained by common risk factors.

One embodiment, among others, is a non-transitory computer-readable medium embodying a program executable in at least one computing device, wherein the program, when executed, can cause the at least one computing device to at least receive proposed trade information comprising an asset and a trade recommendation associated with the asset; calculate a proposed trade alpha for the proposed trade information that specifies an expected market performance of the proposed trade information in comparison to a benchmark; calculate an asset alpha for the asset based on the proposed trade alpha; generate a ranking of the asset among a plurality of assets based on the asset alpha; divide the ranking into a number of segments; assign an indicator number to each of the plurality of assets in the ranking based on a rank position associated with each of the plurality of assets and the number of segments; and encode for display on a client device a user interface that includes the asset and the indicator number associated with the asset.

Another embodiment, among others, is a system that comprises at least one computing device and an application executable by the at least one computing device. The application, when executed, can cause the at least one computing device to receive proposed trade information comprising a respective asset and a trade recommendation associated with the respective asset; calculate a proposed trade expected alpha for the proposed trade information, wherein the proposed trade expected alpha specifies an expected market performance of the proposed trade information in comparison to a first benchmark; calculate a proposed trade expected alpha average for the respective asset based on a plurality of proposed trades that comprises the respective asset; determine an asset expected alpha for the respective asset based on the proposed trade expected alpha average, wherein the asset expected alpha specifies an expected market performance of the respective asset in comparison to a second benchmark; generate a ranking of the respective asset among a plurality of assets based on the asset expected alpha associated; and determine an indicator number to assign each of the plurality of assets based on a rank position of each of the plurality of assets and a number of segments associated with the ranking.

Another embodiment, among others, is a method that comprises the steps of receiving, in a computing device, a plurality of proposed trades that comprise a respective asset and a trade recommendation associated with the respective asset; calculating, in the computing device, a proposed trade expected alpha for each of the plurality of proposed trades, wherein the proposed trade expected alpha specifies an expected market performance of one of the plurality of proposed trades in comparison to a market benchmark; calculating, in the computing device, a proposed trade expected alpha average for the respective asset based on a subset of the plurality of proposed trades comprising the respective asset; determining, in the computing device, an asset expected alpha for each of a plurality of assets based on the proposed trade expected alpha average associated with each of the plurality of assets; generating, in the computing device, a ranking of the plurality of assets based on the asset expected alpha associated with each of the plurality of assets; dividing, in the computing device, the ranking into a number of segments; determining, in the computing device, an indicator number to assign to individual ones of the plurality of assets based on a rank position associated with each of the plurality of assets and the number of segments associated with the ranking; and encoding, in the computing device, for display on a client device a user interface that specifies the indicator number corresponding with the one of the plurality of assets.

Other embodiments, systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an example of a networked environment, according to various embodiments of the present disclosure.

FIGS. 2A through 2C illustrate example user interfaces rendered by a computing device in the networked environment, according to various embodiments of the present disclosure.

FIG. 3 is an example user interface that renders a stock chart illustrating the efficacy of an indicator number, according to various embodiments of the present disclosure.

FIGS. 4A and 4B are flowcharts illustrating examples of functionality implemented by an asset indicator application, according to various embodiments of the present disclosure.

FIG. 5 is a schematic block diagram that provides one example illustration of a computing environment employed in the networked environment of FIG. 1 according to various embodiments of the present disclosure.

### DETAILED DESCRIPTION

Disclosed herein are various embodiments for generating a market signal, or an alert, concerning an individual asset that is indicative of an activity that is unexplained by common risk factors. The market signal may be used, for example, to predict price changes of an asset. In addition, the market signal may be uncorrelated by removing the impact of general market movement factors.

Many investors may get assistance from a broker with their investment decisions. A broker may provide insights such as market trends and stock prices that are likely to increase or decline. For example, a broker may send an investor a proposed trade that comprises a security and a trade recommendation associated with the security. A proposed trade may represent a trade idea, a stock tip, and other investment recommendations. A security may include financial instruments, such as stock of a publicly-traded corporation, a bond, options, and other financial instruments. A trade recommendation may include taking a short position, a long position, an option and other financial transactions related to a security.

Investors may evaluate a proposed trade based on how it will perform in comparison to a market benchmark, such as a market index, a regional index, an industry index, or other investment benchmarks. Investors may also consider whether the proposed trades are suited for their investment goals. For example, an investor may consider the potential return on investment, an amount of time needed to achieve a desired return, investment risks, investment volatility, and other investment factors. However, selecting a financial instrument, a trading strategy, and executing the trading strategy at the appropriate time can be challenging.

Various embodiments of the present disclosure generate an indicator signal for an asset which is not explained by general market factors such as stock momentum, stock volatility, stock valuation, stock size, industry and other common effects. The indicator signal may represent a prediction of a price change of the asset. Depending on the indicator signal for the asset, an investment manager can determine an opportune time to execute a trading strategy for the asset. For example, a company that has a maximum indicator value can indicate a favorable time to buy stock in the company because the maximum indicator value may represent that the stock is predicted to outperform the market. As such, a potential investment in the stock may achieve a greater financial return than an investment aligned with a market benchmark. In the following discussion, a general description of the system and its elements is provided, followed by a discussion of the operation of the same.

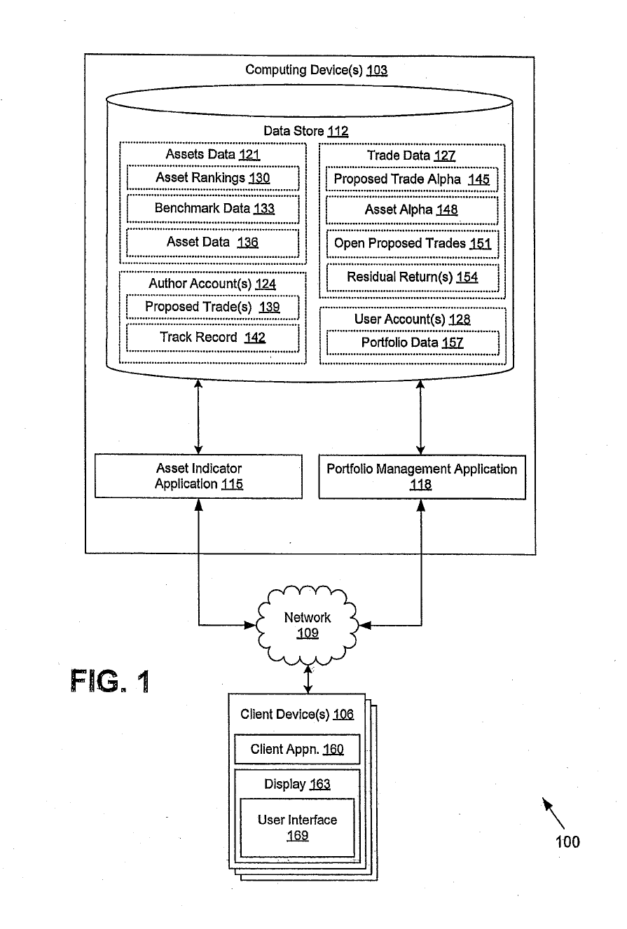

With reference to FIG. 1, shown is a networked environment 100, according to various embodiments of the present disclosure. The networked environment 100 includes a computing environment 103 and one or more client devices 106 in data communication via a network 109. The network 109 may include, for example, the Internet, intranets, extranets, wide area networks (WANs), local area networks (LANs), wired networks, wireless networks, cable networks, satellite networks, or other suitable networks, etc., or any combination of two or more such networks.

The computing environment 103 may comprise, for example, a server computer or any other system providing computing capability. Alternatively, the computing environment 103 may employ a plurality of computing devices that are arranged, for example, in one or more server banks or computer banks or other arrangements. Such computing devices may be located in a single installation or may be distributed among many different geographical locations. For example, the computing environment 103 may include a plurality of computing devices that together may comprise a hosted or “cloud” computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data may be stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include an asset indicator application 115, a portfolio management application 118, and other applications, services, processes, systems, engines, or functionality not discussed in detail herein. The asset indicator application 115 may be executed to generate an indicator signal for individual assets. The asset indicator application 115 may also generate an indicator signal for groups of assets, such as an index, a basket, and other suitable asset groups. The indicator signal may be represented as an indicator number. The indicator number for each asset may be generated daily, weekly, monthly, upon request, and at other suitable intervals. The generated indicator number for each asset may be rendered for display on a user interface. In some embodiments, the indicator number may be used for determining whether the price of an asset will likely increase or decrease.

The portfolio management application 118 may also be executed to facilitate management of various investments of an investor. To this end, the portfolio management application 118 may facilitate investment portfolio management, calculating investment returns, research tools, and/or other suitable functions for an investor.

The data stored in the data store 112 may include, for example, assets data 121, author accounts 124, trade data 127, user accounts 128 and other data. The assets data 121 may include various data associated with an asset, such as a security, an index, a basket, and other suitable financial instruments. The assets data 121 may include asset rankings 130, benchmark data 133, asset data 136, and other investment data. The asset rankings 130 may include a ranking position associated with each of the assets. The asset rankings 130 may also include information related to a number of segments associated with the rankings. For example, a ranking of 50 stocks may be divided into ten segments. The top ranked segment may include the five highest ranked stocks and the lowest ranked segment may include the lowest ranked stocks in the rankings. In addition, the rankings associated with each stock may be recalculated on a periodic basis. The stocks may be ranked according to various factors, such as a calculated expected relative-to-market return, historical performance data, trade data 127, author accounts 124, and other suitable financial metrics.

The benchmark data 133 may comprise data associated with industry benchmarks, regional benchmarks, a stock index, or other asset benchmarking standards. The data associated with these benchmarks may include a list of securities associated with a benchmark, the corresponding security price, and other security data related to the benchmark. The asset data 136 may include various data related to a financial instrument. A financial instrument may include an ownership position in a stock, a creditor relationship in a bond, rights to ownership represented by an option, and other suitable rights to financial instruments. The related financial instruments data may include an earnings report, an income statement, a balance sheet, a cash flow statement, an annual report, earnings announcement information, a SEC filing, a debt profile, and other financial statements related to an asset.

The author accounts 124 may correspond to accounts managed by individuals that provide proposed trades to investors. The author account 124 may be managed by a broker, a broker institution, and other entities that provide financial instrument recommendations. In some embodiments, an individual author account 124 may include proposed trades 139 and a track record 142. The proposed trades 139 may comprise a recommended asset and a trade recommendation associated with the recommended asset. For example, a broker may send a proposed trade to a client that recommends taking a long position in Walmart stock. In this example, the broker may believe that the price of Walmart's stock is likely to go up. The broker may provide proposed trades based on research and experience.

The track record 142 may comprise data related to tracking the performance of the proposed trades 139 created by an author, e.g., a broker. The data may be used to identify authors who have historically created profitable trade ideas. The data may also be used to identify new proposed trades that are likely to outperform a market benchmark. In other words, new proposed trades from authors who have historically suggested profitable proposed trades will likely outperform some benchmark. In addition, the data may be used by the asset indicator application 115 to determine the indicator number for each of the securities.

The track record 142 may comprise an average residual return of the securities included in the proposed trades created by an author, where “residual return” is a security return from which common risk effects have been removed. The track record 142 may also comprise a calculated measure of the author's historical Sharpe ratio. The historical Sharpe ratio may represent an average return or residual return with the impact of market volatility occurring during the time period removed. The historical Sharpe ratio may represent a measure for calculating risk-adjusted returns. In other words, the historical Sharpe ratio may be determined by scaling historical average returns or residual returns of the proposed trades of the author by the standard deviation of the residual returns.

The track record 142 may also include a hit rate associated with the proposed trades 139. The hit rate may represent a percentage of previous proposed trades 139 which were followed by returns or residual returns in the direction predicted by the author.

The trade data 127 may include data related to calculating a proposed trade alpha 145 and an asset alpha 148, open proposed trades 151, and residual returns 154. The proposed trade alpha 145 may represent a calculation of an expected performance of a proposed trade 139 relative to a benchmark. For example, a calculation of the expected performance of the proposed trade 139 may be compared to a benchmark associated with a security of the proposed trade 139. That is, the proposed trade alpha 145 is a calculation of an expected residual return of the proposed trade 139. In other words, proposed trade alpha 145 may represent a determination of the degree to which the proposed trade 139 will outperform, underperform, be equivalent to a relevant benchmark, and other determinations relative to the benchmark. The proposed trade alpha 145 can be calculated at any time after a proposed trade 139 is opened.

The asset alpha 148 may represent a calculation of an expected performance of a respective asset relative to a benchmark. That is, the asset alpha 148 may represent a calculation of an expected performance of an asset in comparison to a relative benchmark associated with the asset. For instance, the asset alpha 148 may represent a determination of the degree to which a stock is expected to outperform a benchmark, underperform the benchmark, be equivalent to the benchmark, and other determinations relative to the benchmark.

The open proposed trades 151 may represent data associated with proposed trades that are still open, where “open” indicates that the author has not yet determined that the proposed trade should be closed. The data may include a number of days since the proposed trade was opened, an indication as to whether the open proposed trade 151 was opened within a number of days following an earnings announcement for the security, an average alpha associated with the proposed trade, and other proposed trade data.

The residual returns 154 may represent security returns from which the effects of common risk factors have been removed. Common risk factors for a security may include stock size, stock valuation, an industry or sector associated with the security, and other common factors.

In some embodiments, a user account 128 may correspond to accounts managed by individuals. The user account may be managed by a user such as an individual investor or an investment manager of an investment portfolio. The user account 128 may include portfolio data 157 associated with an individual user account. The portfolio data 157 may represent data associated with the various financial instruments associated with the user. For example, the portfolio data 157 may include data on the stocks, bonds, options, mutual funds, and other financial instruments associated with the user.

The client device 106 is representative of a plurality of client devices that may be coupled to the network 109. The client device 106 may comprise, for example, a processor-based system such as a computer system. Such a computer system may be embodied in the form of a desktop computer, laptop computer, personal digital assistant, cellular telephone, smartphone, set-top box, web pad, tablet computer system, game console, electronic book reader, or other devices with like capability. The client device 106 may include a display 163. The display 163 may comprise, for example, one or more devices such as liquid crystal display (LCD) displays, gas plasma-based flat panel displays, organic light emitting diode (OLED) displays, LCD projectors, or other types of display devices, etc.

The client device 106 may be configured to execute various applications such as a client application 160 and/or other applications. The client application 160 may be executed in a client device 106, for example, to access network content served up by the computing environment 103 and/or other servers, thereby rendering a user interface 169 on the display 163. The client application 160 may, for example, correspond to a browser, a mobile application, etc., and the user interface 169 may correspond to a network page, a mobile application screen, etc. The client device 106 may be configured to execute applications beyond the client application 160 such as, for example, browsers, mobile applications, email applications, social networking applications, and/or other applications.

Next, a general description of the operation of the various elements of the networked environment 100 is provided. To begin, a user (e.g. a broker) operating an author account 124 may create a proposed trade 139 that includes a security and a trade recommendation. The broker may send the proposed trade 139 to a client associated with a user account 128. The asset indicator application 115 monitors the proposed trades 139 that are sent to the user account 128 and stores the proposed trades 139 in the data store 112. Each author account 124 may create a plurality of proposed trades 139.

The asset indicator application 115 may determine a residual return 154 for individual assets. The residual return 154 removes the effects of general common risk factors like stock size, stock valuation, and the industry associated with the security. As such, the residual return 154 may represent a “pure” security-specific return. For example, the residual return 154 may represent a financial return of Starbuck Corp. stock without the impact of the size, valuation, or industry associated with Starbucks stock.

The residual returns 154 may be determined based on a factor model that decomposes a return of a security into separate terms. The asset indicator application 115 may determine how much a particular general common risk factor term contributed to the return of the security. For example, suppose that over a period of a year, Starbucks Corp. stock has a return of 30%. The factor model can determine how much of the 30% return can be attributed to the size, valuation, the industry, and other common risk factors associated with Starbucks Corp. stock.

In one embodiment, among other possible embodiments, the factor model may use ordinary least square regression (OLS) to determine how each of a plurality of common risk factors contributed to the market return. In this one embodiment, the residual return 154 may be calculated by: STOCK_RETURN=coefficient(mmt)*MOMENTUM+coefficient(vol)*VOLATILITY+coefficient(s)*SIZE+coefficient(v)*VALUE+coefficient(ind)*INDUSTRY_OR_SECTOR+residual (including intercept). Linear regressions were run with the inputs of STOCK_RETURN, MOMENTUM, VOLATILITY, SIZE, VALUE, INDUSTRY_OR_SECTOR across a cross-section of securities during a particular time period, to determine the coefficient for each factor. The coefficient for each factor represents the exposure of the market's return to that factor. Put another way, the coefficient for each factor represents the contribution of that factor to the market return. For example, coefficient(v) represents the return resulting from the influence of VALUE as found by OLS. The residuals of this regression gives us a vector of the residual returns for each stock for that time period.

The asset indicator application 115 may determine a proposed trade alpha 145 for an individual proposed trade 139. The asset indicator application 115 may use data from the open proposed trades 151, the residual returns 154, the track record 142, the asset data 136, and other data related to the proposed trade 139. In one embodiment, among others, the proposed trade alpha 145 may be determined by calculating an expected residual return for the proposed trade 139. The expected residual return may be calculated with the following:

expectedResidualReturn=intercept(a constant per month)+ideaDaysOld*ideaDaysOldCoefficient+idealsOpen*(idealsOpenCoefficient+ideaAuthorTrackRecord*ideaAuthorTrackRecordCoefficient+isStockPostEarnings*isStockPostEarningsCoefficient).

The intercept may represent a constant calculated on a periodic basis. For example, the constant may represent an average residual return of the proposed trade 139 for a period of time. In another example, the intercept may be calculated using a weighting system. The constant may be adjusted based on the volume of proposed trades 139. In addition, the ideaDaysOld may represent a number of days since the proposed trade 139 was opened. The IdealsOpen may represent whether the proposed trade 139 is open or not. The ideaAuthorTrackRecord may represent one of a plurality of calculations related to determining the historical performance of the author accounts 124, such as the residual return 154, Sharpe ratio, the hit rate, and other performance metrics. The isStockPostEarnings may represent whether or not the proposed trade 139 was submitted within a period of time after an earnings announcement. For example, the period of time may be configured to 10 days. The various embodiments of the present disclosure use this component in the calculation of the proposed trade alpha because it has been determined that few people have an information advantage after an earnings announcement since all of the latest company information is public.

Each component (including the intercept) discussed above may be multiplied by −1 if the proposed trade 139 is a short position, because a short position predicts negative alpha rather than positive alpha. In addition, the coefficients may be weighted for each factor (and can be negatively weighted) and the intercept may be just an offset. All may be determined by regression analysis against actual residual returns from historical training set. The regression analysis may be performed for each region independently, and the coefficients may vary by region.

In addition, the asset indicator application 115 may also determine an asset alpha 148 for individual assets. In one embodiment, among others, the asset alpha 148 may be determined by calculating an average of the proposed trade alphas 145 associated with a proposed trade 139 that includes a particular security. For instance, the asset alpha 148 for Apple, Inc. stock can be determined by calculating the average of the proposed trade alphas 145 associated with a proposed trade 139 that includes Apple, Inc. stock.

Further, the asset indicator application 115 may be configured to calculate the track record 142 for individual author accounts 124. The asset indicator application 115 may use historical data associated with the proposed trades 139 to determine residual returns 154 for the proposed trades 139 created by the author account 124. In some embodiments, the asset indicator application 115 groups the author accounts 124 by the number of proposed trades 139, then for each group the asset indicator application 115 calculates residual returns, Sharpe ratios, and hit rates. The asset indicator application 115 can calculate the standard deviation of these calculations, standardize each calculation, and then standardize the averages.

Next, the asset indicator application 115 may generate a ranking of a plurality of assets. The asset indicator application 115 may generate rankings based on the residual returns 154, the asset alpha 148, the proposed trade alpha 145, the track record 142, and other data related to the assets. After a ranking has been generated, the asset indicator application 115 may determine which of a plurality of segments each asset falls within. Each segment may be associated with one of a plurality of indicator numbers. Thus, the asset indicator application 115 may assign an indicator number to each asset based on the segment associated with the asset. The indicator number may be displayed in association with the asset on a user interface 169.

In one non-limiting example, after the asset alpha 148 has been generated for a plurality of stocks, the asset indicator application 115 may generate a ranking of the stocks according to the asset alpha 148 associated with each stock. The stocks are divided into segments according to their position within the ranking. In this example, there are ten segments, and each segment is associated with an indicator number between one and ten. Therefore, the lowest ranked stocks may be associated with a segment associated with an indicator value of one. All of the stocks in the segment will be assigned an indicator number of one. The highest ranked stocks may be associated with another segment that has an indicator value of ten. Thus, all of the stocks in this other segment will be assigned an indicator number of 10. The asset alpha 148, the proposed trade alpha 145, and the rankings can be recalculated every day. Thus, the indicator number associated with stock may change daily.

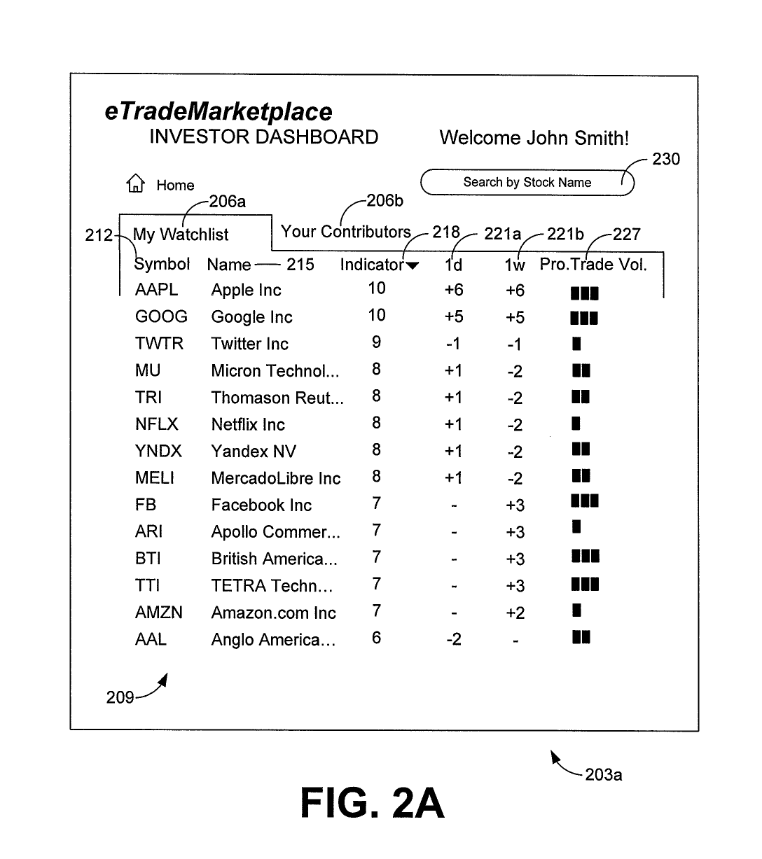

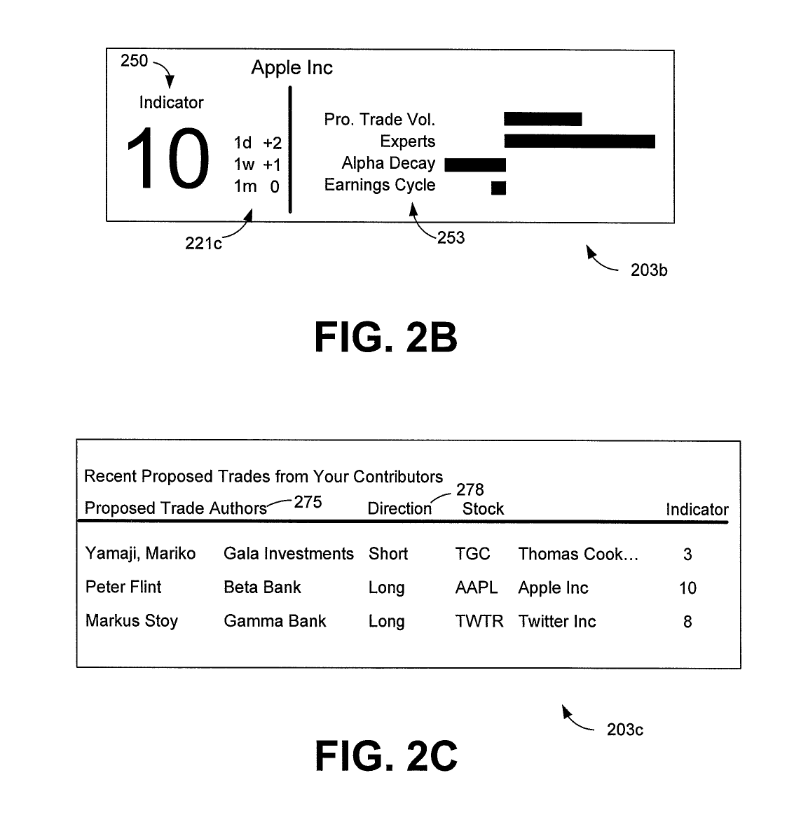

Referring next to FIG. 2A, shown is an example user interface 203a rendered by a client application 160 (FIG. 1) executed by a client device 106 (FIG. 1) in the networked environment 100 (FIG. 1). The user interface 203a is associated with a particular scenario involving a personalized watchlist 206a for a user account 128. In this scenario, a user is viewing a list 209 of stocks that have been selected by the user. The user may add or remove stocks from their list 209. A user may have received a plurality of propose trades 139 and the user can add individual stocks to the watchlist 206a in order to continue monitoring the indicator numbers associated with each stock.

In the illustrated embodiment, the watchlist 206a includes a stock symbol 212, a stock name 215, an indicator value 218, an indicator change from the previous day 221a, an indicator change from the previous week 221b, and a current proposed trade volume 227. The stock symbol 212 and the stock name 215 may be configured to be clickable on the user interface 203 to provide additional information associated with the stock.

The indicator value 218 displays the indicator number associated with the stock for the current day. The current proposed trade volume 227 may display a signal that represents whether the indicator value 218 is based on low, medium, or high underlying proposed trade activity. The user interface 203 may also include a search query component 230 in order for the user to enter a search query or other identifying information for the stocks.

Turning now to FIG. 2B, shown is an example user interface 203b rendered by a client application 160 (FIG. 1) executed by a client device 106 (FIG. 1) in the networked environment 100 (FIG. 1). The user interface 203b is associated with another usage scenario for displaying an indicator number associated with a security. In one scenario, the user interface 203b may be presented after clicking on the stock symbol or the stock name in the user interface 203a (FIG. 2A). In another scenario, the user interface 203b may be displayed in response to a user entering the stock information in the search component 230. The user interface 203b provides a detailed view for a particular stock and an associated indicator number 250. The user interface 203b includes indicator components 253 that contributed to a determination of the indicator number 250. In the illustrated embodiments, the indicator components 253 displayed include a sentiment signal, an expert signal, an alpha decay signal, and an earnings cycle signal. The sentiment signal may represent a sum of long and short positions associated with the proposed trades 139 for a stock. The expert signal may represent broker sentiment emphasizing predictions from author accounts 124 with the strongest historical track records 142. The alpha decay signal may represent a decreasing conviction over time as proposed trades represented in the expert signal and the sentiment signal age. The earnings cycle may represent a weighted score that deemphasizes proposed trades 139 submitted within a period of time after an earnings event.

Moving on to FIG. 2C, shown is an example user interface 203c rendered by a client application 160 (FIG. 1) executed by a client device 106 (FIG. 1). The user interface 203c illustrates a view of proposed trades 139 from author accounts 124 associated with a user account 128. In one scenario, a user is viewing the user interface 203a and the user selects the 206b tab. The user interface 203c displays a list 275 of author accounts 124 associated with a user account 128. In the user interface 203c, each author account 124 is displayed in association with the proposed trade 139 created by the author account 124. In the illustrated embodiment, the proposed trade 139 includes a trade recommendation and the stock. The trade recommendation is illustrated as a direction 278 in the user interface 203c. The direction 278 may refer to a taking a short position, a long position, and other positions associated with financial instruments. In one embodiment, among others, the user may enter author accounts 124 that the user would like to view. For example, a user may desire to follow the proposed trades 139 of prominent investment professionals. Alternatively, the list 275 of proposed trade authors may represent a plurality of author accounts 124 that have sent proposed trades to the user. For example, the user may receive proposed trades from several brokers.

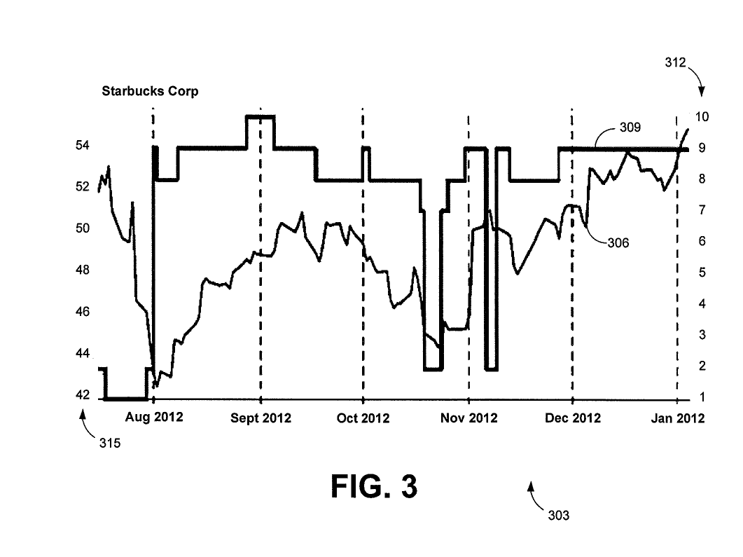

Referring next to FIG. 3, shown is an example user interface 303 rendered by a client application 160 (FIG. 1) executed by a client device 106 (FIG. 1) in the networked environment 100. As shown in FIG. 3, the user interface 303 renders a stock chart illustrating the efficacy of the indicator number in comparison to a stock price.

The user interface 303 may be configured to allow a user to see the past performance of each stock relative to a market benchmark. A combination of pre-set time horizons and a dynamic date range selector may be configured to illustrate how the indicator number performed throughout the various stock-specific and market-driven event cycles that can affect a company's valuation.

In FIG. 3, a graph of a stock price 306 and a graph of a corresponding indicator number 309 for Starbucks are shown. A right portion 312 of the user interface 303 displays a range of indicator numbers from one to ten. A left portion 315 of the user interface 303 displays a range of stock price values.

Starbucks is one of the more closely followed equities in the United States, with more than 75% institutional ownership leading up to the time period displayed in FIG. 3. Fortunately for its shareholders, SBUX has been on a steady upward climb on a year-over-year basis. Within this larger cycle there have been dips, however, and correctly timing entry points can be a critical component of alpha.

On Jul. 16, 2012 the indicator number 309 for Starbucks turned strongly bearish. Within two weeks a disappointing earnings report had driven the stock down 17%. Various embodiments of the present disclosure correctly identified this as an overreaction, and the indicator number 309 spiked back up ahead of an 18% rebound.

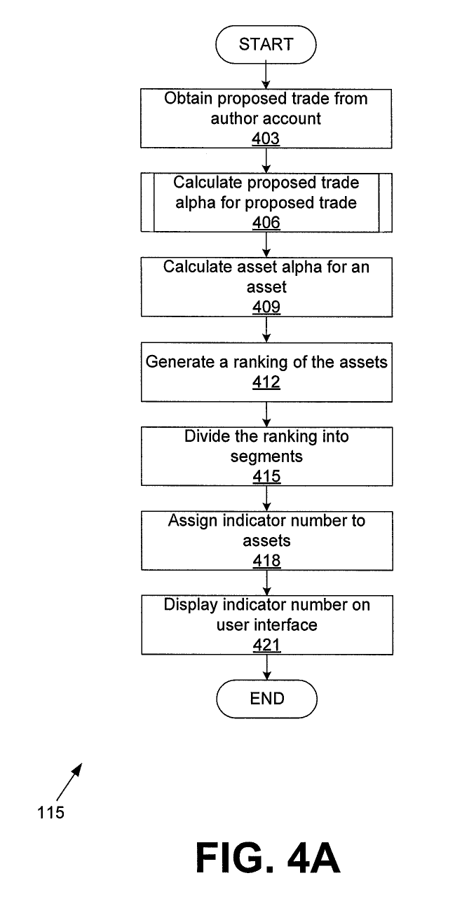

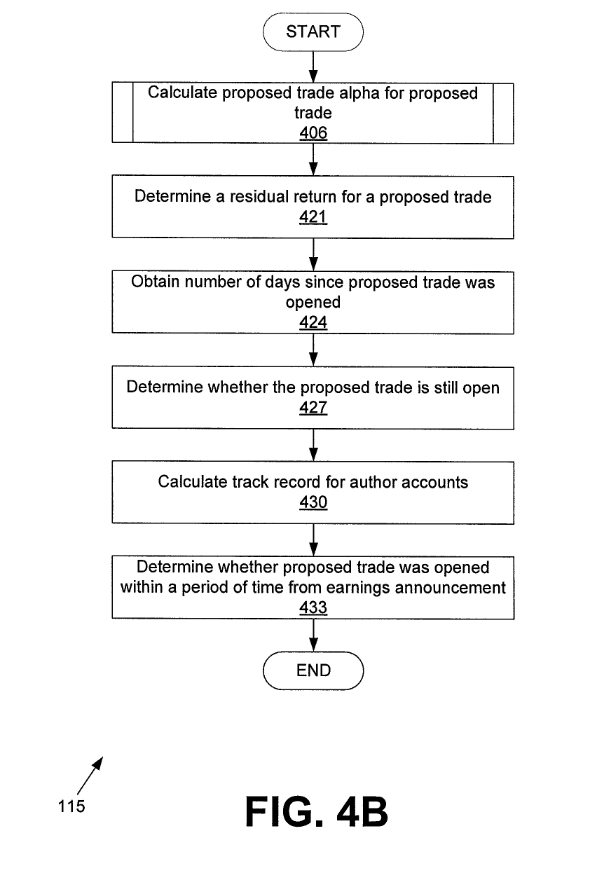

Referring next to FIG. 4A, shown is a flowchart that provides one example of the operation of the asset indicator application 115 according to various embodiments. It is understood that the flowchart of FIG. 4A provides merely an example of the many different types of functional arrangements that may be employed to implement the operation of the asset indicator application 115 as described herein. As an alternative, the flowchart of FIG. 4A may be viewed as depicting an example of elements of a method implemented in the computing environment 103 (FIG. 1) according to one or more embodiments.

Beginning with box 403, the asset indicator application 115 obtains proposed trades 139 from author accounts 124 (FIG. 1). For example, the asset indicator application 115 monitors proposed trades 139 being sent from author accounts 124 to user accounts 128. In other words, the asset indicator application 115 captures the distribution of proposed trades 139 and stores them in the data store 112. In box 406, the asset indicator application 115 calculates the proposed trade alpha 145 for a proposed trade 139. In box 409, the asset indicator application 115 calculates an asset alpha 148 for an asset based on the proposed trade alphas that are associated with the asset. In box 412, the asset indicator application 115 generates a ranking of the assets. In one embodiment, the asset indicator application 115 generates a ranking of a plurality of securities based on the asset alpha 148 associated with each security. In box 415, the asset indicator application 115 divides the ranking into a plurality of segments. For example, the rankings can be divided into ten segments. In box 418, the asset indicator application 115 assigns an indicator number to each asset based on the rank position of the asset and the segment associated with the rank position. For example, if 200 stocks are ranked and divided into ten segments, the top twenty ranked stocks would be assigned an indicator number of ten. The next twenty ranked stocks (e.g., ranked from 21^{st} to 40^{th}) would be assigned an indicator number of nine. The remaining stocks would be assigned an indicator number from one to eight based on their rank position and an associated segment. In box 421, asset indicator application 115 renders for display the indicator number in user interfaces executed on a client device 106. The indicator number can be rendered for display in association with the corresponding stock, as shown in example user interfaces FIGS. 2A through 2C. Thereafter, the portion of the asset indicator application 115 ends.

Referring next to FIG. 4B, shown is a flowchart that provides another example of the operation of the asset indicator application 115 according to various embodiments. It is understood that the flowchart of FIG. 4B provides merely an example of the many different types of functional arrangements that may be employed to implement the operation of the asset indicator application 115 as described herein. As an alternative, the flowchart of FIG. 4B may be viewed as depicting an example of elements of a method implemented in the computing environment 103 (FIG. 1) according to one or more embodiments. Particularly, the flowchart illustrated in FIG. 4B provides one example of calculating proposed trade alpha for proposed trades as discussed above with regard to box 406.

In box 421, the asset indicator application 115 determines a residual return 154 for a proposed trade 139. In one embodiment, the residual return 154 may be determined based on linear regression calculations of a stock return and general common risk factors. In another embodiment, the residual return 154 may be averaged over a plurality of proposed trades 139. In box 424, the asset indicator application 115 obtains a number of days since the proposed trade 139 was opened. In box 427, the asset indicator application 115 determines whether the proposed trade 139 is still open. In box 430, the asset indicator application 115 calculates a track record 142 for an author account 124. In one embodiment, the residual returns 154, the Sharpe ratios, the hit rates are calculated for individual author accounts 124. The track record 142 calculations are based on the previous proposed trades created by the author account 124. In box 433, the asset indicator application 115 determines whether the proposed trade 139 was opened within a period of time from an earnings announcement. The period of time can be preconfigured. For example, it has been determined that proposed trades created within ten days after an earnings announcement have not generated as much of a residual return as proposed trades created outside of the ten day period. Thus, in one embodiment, the period of time may be preconfigured, for example, to 10 days.

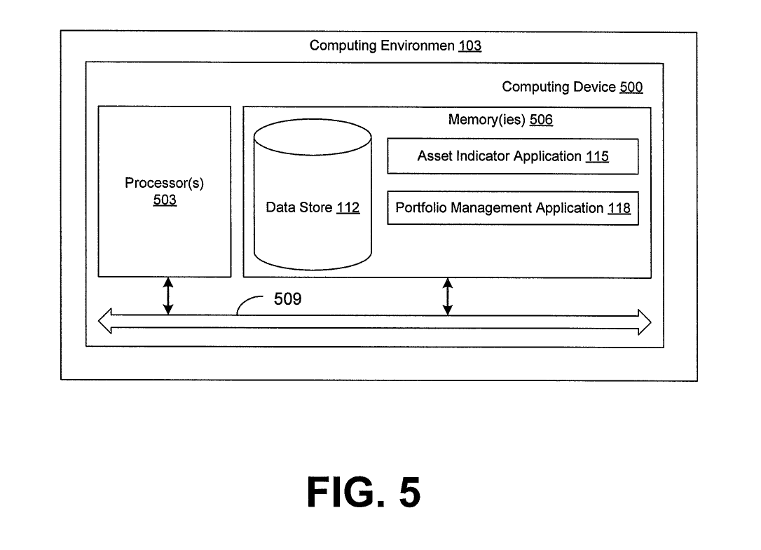

With reference to FIG. 5, shown is a schematic block diagram of the computing environment 103 according to an embodiment of the present disclosure. The computing environment 103 includes one or more computing devices 500. Each computing device 500 includes at least one processor circuit, for example, having a processor 503 and a memory 506, both of which are coupled to a local interface 509. To this end, each computing device 500 may comprise, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are asset indicator application 115 and portfolio management application 118, and potentially other applications. Also stored in the memory 506 may be a data store 112 and other data. In addition, an operating system may be stored in the memory 506 and executable by the processor 503.

It is understood that there may be other applications that are stored in the memory 506 and are executable by the processor 503 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the asset indicator application 115 and the portfolio management application 118, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4A and 4B show the functionality and operation of an implementation of portions of the security indication application 115. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 4A and 4B show a specific order of execution, it is understood that the order of execution may differ from that which is depicted. For example, the order of execution of two or more blocks may be scrambled relative to the order shown. Also, two or more blocks shown in succession in FIGS. 4A and 4B may be executed concurrently or with partial concurrence. Further, in some embodiments, one or more of the blocks shown in FIGS. 4A and 4B may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the asset indicator application 115 and the portfolio management application 118, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the asset indicator application 115 and the portfolio management application 118, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium embodying a program executable in at least one computing device, wherein the program, when executed, causes the at least one computing device to at least:
receive proposed trade information comprising an asset and a trade recommendation associated with the asset;
calculate a proposed trade alpha for the proposed trade information that specifies an expected market performance of the proposed trade information in comparison to a benchmark;
calculate an asset alpha for the asset based on the proposed trade alpha;
generate a ranking of the asset among a plurality of assets based on the asset alpha;
divide the ranking into a number of segments;
assign an indicator number to each of the plurality of assets in the ranking based on a rank position associated with each of the plurality of assets and the number of segments; and
encode for display on a client device a user interface that includes the asset and the indicator number associated with the asset.

2. The non-transitory computer-readable medium of claim 1, wherein the asset represents at least one of a stock of a corporation, a bond, an option, an index, or a basket.

3. The non-transitory computer-readable medium of claim 1, wherein a highest indicator number is assigned to a subset of the plurality of assets associated with a plurality of highest ranked positions in the ranking.

4. A system, comprising:
at least one computing device;
an application executable by the at least one computing device, wherein the application, when executed, causes the at least one computing device to:
receive proposed trade information comprising a respective asset and a trade recommendation associated with the respective asset;
calculate a proposed trade expected alpha for the proposed trade information, wherein the proposed trade expected alpha specifies an expected market performance of the proposed trade information in comparison to a first benchmark;
calculate a proposed trade expected alpha average for the respective asset based on a plurality of proposed trades that comprises the respective asset;
determine an asset expected alpha for the respective asset based on the proposed trade expected alpha average, wherein the asset expected alpha specifies an expected market performance of the respective asset in comparison to a second benchmark;
generate a ranking of the respective asset among a plurality of assets based on the asset expected alpha associated; and
determine an indicator number to assign each of the plurality of assets based on a rank position of each of the plurality of assets and a number of segments associated with the ranking.

5. The system of claim 4, wherein calculating a proposed trade expected alpha for the proposed trade information that specifies an expected market performance of the proposed trade information in comparison to a first benchmark further comprises determining an average expected alpha for the proposed trade information.

6. The system of claim 5, wherein calculating a proposed trade expected alpha for the proposed trade information that specifies an expected market performance of the proposed trade information in comparison to a first benchmark further comprises:
obtaining a number of days since the proposed trade information was created; and
determining that the proposed trade information is open.

7. The system of claim 6, wherein calculating a proposed trade expected alpha for the proposed trade information that specifies an expected market performance of the proposed trade information in comparison to a first benchmark further comprises calculating a performance record of a proposed trade author based on a plurality of previous proposed trades associated with the proposed trade author.

8. The system of claim 7, wherein calculating a proposed trade expected alpha for the proposed trade information that specifies an expected market performance of the proposed trade information in comparison to a first benchmark further comprises determining whether the proposed trade information was created within a predefined number of days from an earnings announcement associated with the respective asset.

9. The system of claim 7, wherein the performance record of the plurality of previous proposed trades comprises at least one of a hit rate, a Sharpe ratio, or an average return of the plurality previous proposed trades associated with the proposed trade author.

10. The system of claim 9, wherein the hit rate comprises a percentage of the plurality of previous proposed trades in which an asset price of the respective asset moved in a direction of a previous trade recommendation for each of the plurality of previous proposed trades.

11. The system of claim 10, wherein the Sharpe ratio comprises scaling a residual return average of a plurality of residual returns associated with the plurality of previous proposed trades by a calculated standard deviation of the plurality of residual returns, wherein the plurality of previous proposed trades are associated with the proposed trade author.

12. The system of claim 4, wherein the application further causes the at least one computing device to render for display a network page that includes a buy long recommendation for at least one of a subset of the plurality of assets associated with a highest indicator number.

13. The system of claim 4, wherein the application further causes the at least one computing device to render for display a network page that includes a short recommendation for at least one of a subset of the plurality of assets associated with a lowest indicator number.

14. The system of claim 4, wherein the proposed trade information is created by a broker user account.

15. The system of claim 4, wherein the first benchmark comprises a regional geographic benchmark or an industry benchmark associated with the respective asset.

16. A method comprising:
receiving, in a computing device, a plurality of proposed trades that comprise a respective asset and a trade recommendation associated with the respective asset;
calculating, in the computing device, a proposed trade expected alpha for each of the plurality of proposed trades, wherein the proposed trade expected alpha specifies an expected market performance of one of the plurality of proposed trades in comparison to a market benchmark;
calculating, in the computing device, a proposed trade expected alpha average for the respective asset based on a subset of the plurality of proposed trades comprising the respective asset;
determining, in the computing device, an asset expected alpha for each of a plurality of assets based on the proposed trade expected alpha average associated with each of the plurality of assets;
generating, in the computing device, a ranking of the plurality of assets based on the asset expected alpha associated with each of the plurality of assets;
dividing, in the computing device, the ranking into a number of segments;
determining, in the computing device, an indicator number to assign to individual ones of the plurality of assets based on a rank position associated with each of the plurality of assets and the number of segments associated with the ranking; and
encoding, in the computing device, for display on a client device a user interface that specifies the indicator number corresponding with the one of the plurality of assets.

17. The method of claim 16, wherein calculating, in the computing device, a proposed trade expected alpha for each of the plurality of proposed trades further comprises:
determining, in the computing device, an average expected alpha for one of the plurality of proposed trades;
obtaining, in the computing device, a number of days since the one of the plurality of proposed trades was opened;
determining, in the computing device, that the one of the plurality of proposed trades is open;
calculating, in the computing device, a track record of a proposed trade author based on a plurality of previous proposed trades associated with the proposed trade author; and
determining, in the computing device, whether the one of the plurality of proposed trades was opened within a predefined number of days from an earnings announcement associated with the respective assets.

18. The method of claim 17, wherein calculating, in the computing device, a track record of a proposed trade author further comprises:
calculating, in the computing device, historical residual returns for the plurality of previous proposed trades associated with the proposed trade author;
determining, in the computing device, a Sharpe ratio for the plurality of previous proposed trades associated with the proposed trade author; and
determining, in the computing device, a hit rate for the plurality of previous proposed trades associated with the proposed trade author.

19. The method of claim 18, wherein the hit rate comprising a percentage of the plurality of previous proposed trades in which an asset price of the respective asset moved in a direction of a trade recommendation of one of the plurality of previous proposed trades.

20. The method of claim 18, wherein calculating, in the computing device, historical residual returns for the plurality of previous proposed trades associated with the proposed trade author further comprises performing a linear regression calculation on a plurality of previous asset prices and a plurality of common risk factors.
